(19) United States
(12) Patent Application Publication
(10) Pub. No.: US 2009/0272333 A1
(43) Pub. Date: Nov. 5, 2009

(54) GRIP FOR PET GROOMING COMB

(75) Inventor: Ralph LIN, Taipei (TW)

Correspondence Address: BROWDY AND NEIMARK, P.L.L.C.;624 NINTH STREET, NW, SUITE 300, WASHINGTON, DC, 20001-5303, US

(73) Assignee: HAN LIEN INTERNATIONAL CORP., Taipei (TW)

(21) Appl. No.: 12/236,424

(22) Filed: Sep. 23, 2008

(30) Foreign Application Priority Data
May 1, 2008 (TW) 97207579

(51) Int. Cl. A01K 13/00

(52) U.S. Cl. 119/633; 119/600

(57) ABSTRACT

A grip for a pet grooming comb includes a head portion, a body portion, a concavity at at least one of top and bottom sides of the head portion for accommodation of a user's thumb or forefinger, and two opposite curved surfaces at a junction of the head portion and the body portion to be nestled by a part of the user's hand between the thumb and the forefinger. Thus, the grip of the present invention has an ergonomic design to be operated effortlessly.

### BACKGROUND OF THE INVENTION

1. Field of the Invention

The present invention relates generally to pet supplies, and more specifically to a grip for a pet grooming comb.

2. Description of the Related Art

A conventional grip for a pet grooming comb is generally designed in a bar shape to be held by a user; therefore, the user can hold the grip to force a comb head connected to the grip to approach the skin of a pet as close as possible, thereby combing the pet's hair.

However, when the user holds the bar-shaped grip, a part of the user's hand between the thumb and the index finger can't smoothly nestle on the grip such that the user is difficult to comfortably hold the bar-shaped grip to operate the pet grooming comb; further, the bar-shaped grip may be easy to slip from the user's hand when it is in use. Thus, it can be seen that the conventional bar-shaped grip has the drawback of lacking an ergonomic design, resulting in inconvenience of use.

### SUMMARY OF THE INVENTION

The present invention has been accomplished in view of the above-noted circumstances. It is one objective of the present invention to provide a grip for a pet grooming comb, which can be held by a user comfortably.

It is another objective of the present invention to provide a grip for a pet grooming comb, which won't slip from a user's hand easily.

To achieve these objectives of the present invention, the grip comprises a head portion, a body portion, a concavity at at least one of top and bottom sides of the head portion for accommodation of the user's thumb or forefinger, and two opposite curved surfaces at a junction of the head portion and the body portion to be nestled by a part of the user's hand between the thumb and the index finger.

In an embodiment, the grip further includes a plurality of protrusions provided at each of the curved surfaces and arranged in a straight manner for preventing the grip from slipping from the user's hand.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a grip according to a preferred embodiment of the present invention;

FIG. 2 is an exploded view of the grip according to the preferred embodiment of the present invention;

FIG. 3 is a top view of the grip according to the preferred embodiment of the present invention;

FIG. 4 is a bottom view of the grip according to the preferred embodiment of the present invention;

FIG. 5 is a top view of the grip according to the preferred embodiment of the present invention, showing that the user's hand holds the grip, and

FIG. 6 is similar to FIG. 5, but showing that the user's thumb is placed on the concavity.

### DETAILED DESCRIPTION OF THE INVENTION

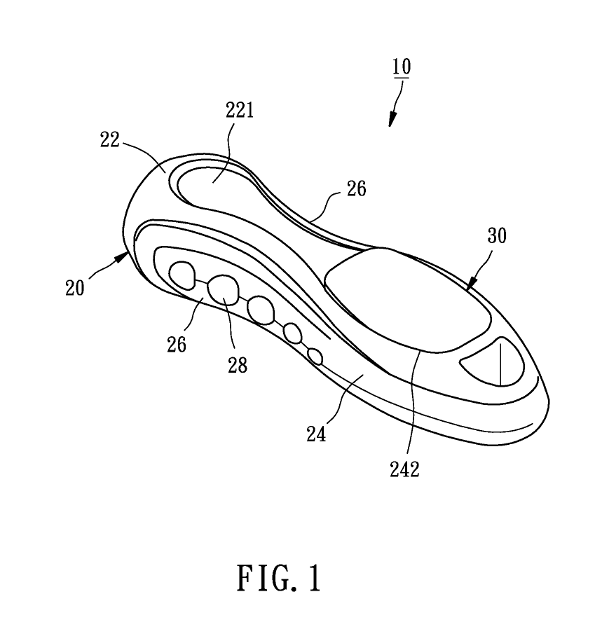

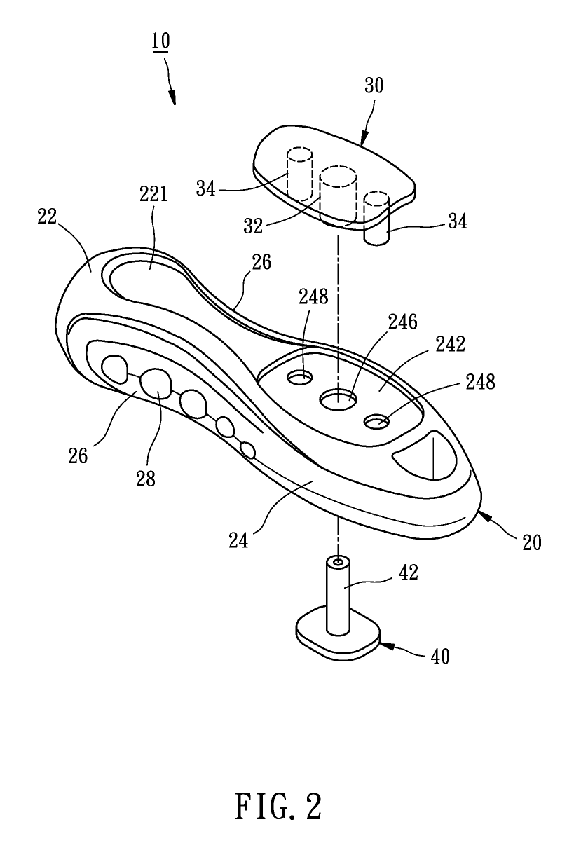

As shown in FIGS. 1 and 2, a grip 10 for a pet grooming comb in accordance with a preferred embodiment of the present invention comprises a grip body 20 and two decorative boards 30 and 40.

The grip body 20 has a head portion 22, a body portion 24, a first curved concavity 221 at each of top and bottom sides of the head portion 22 for accommodation of a user's thumb or forefinger, a rectangular second concavity 242 at a top side of the body portion 24, and a rectangular third concavity 244 at a bottom side of the body portion 24. The second concavity 242 has a larger area than that of the third concavity 244. Further, the body portion 24 has a through hole 246 penetrating through the top and bottom sides thereof and being in communication with the second concavity 242 and the third concavity 244, and two mounting holes 248 recessed from the top side of the body portion 24 towards the bottom side of the body portion 24 with openings in communication with the second concavity 242. The mounting holes 248 are located at places corresponding to two opposite sides the through hole 246. In addition, a junction of the head portion 22 and the body portion 24 is shrunken inwardly to form two opposite inwardly curved surfaces 26, and furthermore a plurality of protrusions 28 are spacedly provided on each of the curved surfaces 26 and arranged in a straight manner from the head portion 22 to the body portion 24 for providing a skidproof effect.

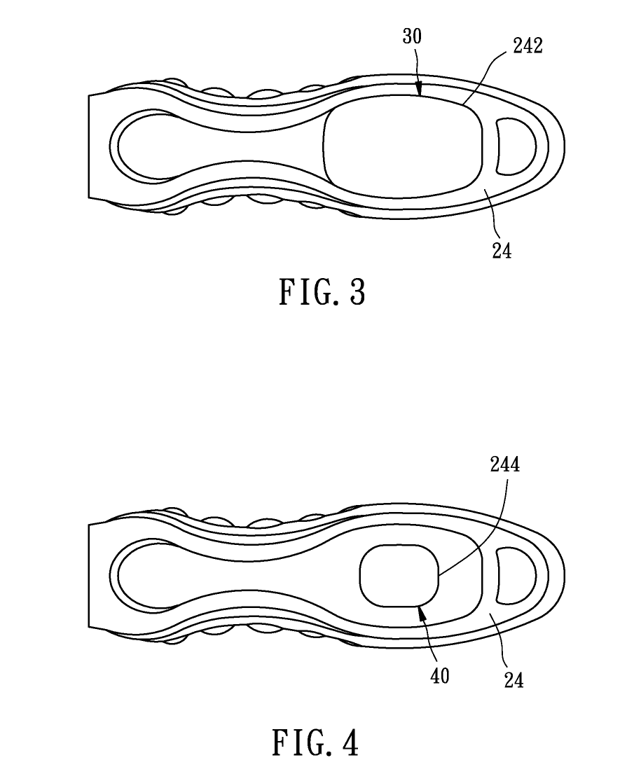

The decorative board 30 has a first post 32 inserted in the through hole 246 of the body portion 24, and two second posts 34 respectively inserted in the mounting holes 248 of the body portion 24 such that the decorative board 30 is accommodated in the second concavity 242, as shown in FIGS. 2 and 3. The decorative board 40 has a third post 42 inserted in the first post 32 of the decorative board 30 through the through hole 246 such that the decorative board 40 is accommodated in the third concavity 244, as shown in FIG. 4. As a result, patterns or trademarks can be provided on the decorative boards 30 and 40 according to the user's need.

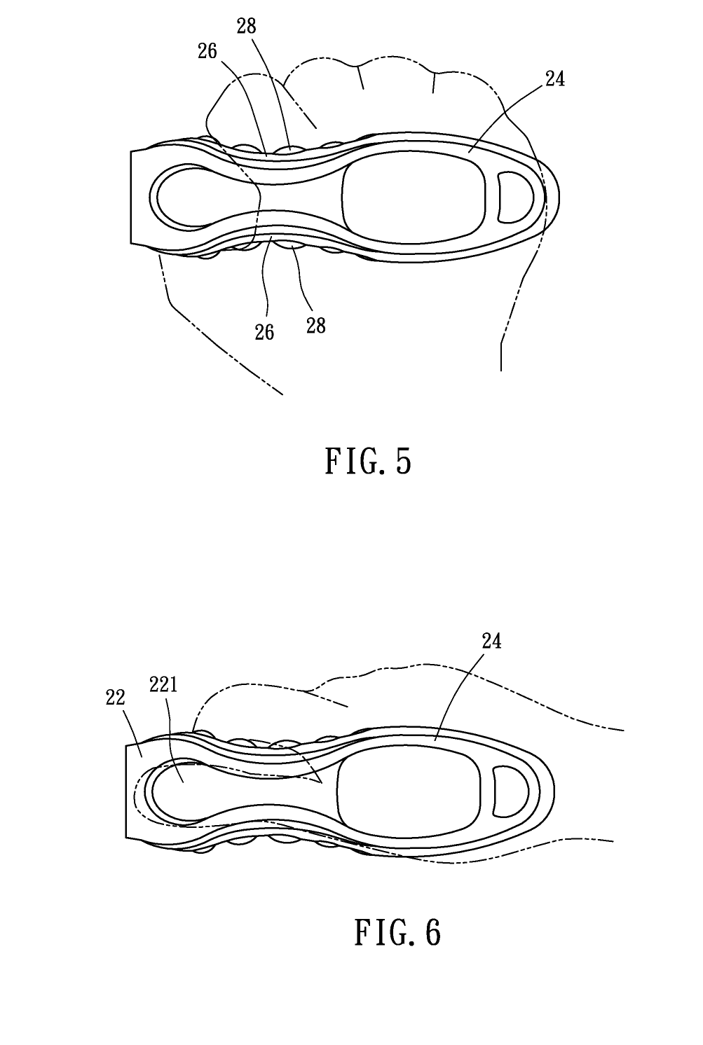

When the user holds the body portion 24, a part of the hand between the thumb and the index finger can smoothly nestle on the curved surfaces 26, as shown in FIG. 5, to facilitate the user to comfortably operate the pet grooming comb; further, the user's thumb or forefinger can be placed on either of the concavities 221 of the top and bottom sides of the head portion 22, as shown in FIG. 6, such that the grip 10 can be operated comfortably and effortlessly due to its ergonomic design; moreover, the protrusions 28 will be in contact with a palm of the hand to prevent the grip 10 from slipping from the user's hand when the user holds the grip 10.

Certainly, the grip of the present invention can be made with various kinds of design on the basis of the spirit of the present invention. For example, the first concavity 221 is not necessary to be formed on each of the top and bottom sides of the head portion 22 as long as it is formed on either of the top and bottom sides of the head portion 22. Further, the body portion 24 can be provided with one or more mounting holes 248, even the mounting hole 248 can be eliminated as long as the body portion 24 has a through hole penetrating therethrough.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A grip for a pet grooming comb, the grip comprising:
a grip body having a head portion, a body portion, a concavity at at least one of top and bottom sides of said head portion, and two opposite curved surfaces at a junction of said head portion and said body portion.

2. The grip as claimed in claim 1, wherein said concavity is formed at each of said top and bottom sides of said head portion.

3. The grip as claimed in claim 1, wherein said concavity has a curved shape.

4. The grip as claimed in claim 1, further comprising a plurality of protrusions spacedly provided at each of said curved surfaces and arranged in a straight manner from said head portion to said body portion.

5. The grip as claimed in claim 1, wherein said body portion is provided at each of top and bottom sides with a concavity for accommodation of a decorative board.

6. The grip as claimed in claim 5, wherein said body portion has a through hole in communication said concavities of said top and bottom sides thereof, and said decorative boards each have a post inserted in said through hole; wherein said post of one of said decorative boards is inserted in said post of the other one of said decorative boards.

7. The grip as claimed in claim 5, wherein said body portion has a through hole in communication with said concavities of said top and bottom sides thereof, and a mounting hole in communication with one of said concavities of said top and bottom sides thereof; one of said decorative boards has a first post inserted in said through hole and a second post inserted in said mounting hole, and the other one of said decorative boards has a third post inserted in said first post through said through hole.

8. The grip as claimed in claim 7, wherein said body portion has two said mounting holes, and said decorative board has two said second posts respectively inserted in said mounting holes.
